(19) United States
(12) Patent Application Publication
(10) Pub. No.: US 2015/0142251 A1
(43) Pub. Date: May 21, 2015

(54) VEHICLE CONTROL BASED ON COLORS REPRESENTATIVE OF NAVIGATION INFORMATION

(71) Applicant: International Business Machines Corporation, Armonk, NY (US)

(72) Inventors: Alfredo Aldereguia, Cary, NC (US); Jeffrey R. Hamilton, Pittsboro, NC (US); Clifton E. Kerr, Durham, NC (US); Grace A. Richter, Raleigh, NC (US)

(73) Assignee: International Business Machines Corporation, Armonk, NY (US)

(21) Appl. No.: 14/086,518

(22) Filed: Nov. 21, 2013

(51) Int. Cl. G06K 9/00; G06K 9/58; G05D 1/02; G06K 9/46

(52) U.S. Cl. CPC G06K 9/00818; G06K 9/4652; G06K 9/58; G05D 1/0234
USPC 701/28

(57) ABSTRACT

Vehicle control based on colors representative of navigation information are disclosed. According to an aspect, a method includes receiving an image of an object surface having multiple colors thereon that are representative of data for use in navigating a vehicle along a pathway. Further, the method includes controlling the vehicle to operate to navigate the pathway based on the image.

### BACKGROUND

1. Field of the Invention

The present invention relates to navigation, and more specifically, to systems and methods for vehicle control based on colors representative of navigation information.

2. Description of Related Art

Efforts have been made to provide autonomous vehicles, such as autonomous automobiles. As known, an autonomous vehicle may refer to a driverless vehicle that moves independently from one location to another location, with or without human passengers. In addition, advanced driver assist systems have been introduced to help a driver in the driving process. These systems can increase safety and reduce the need for human effort.

Some vehicles provide systems for assisting drivers in navigating between different locations. For example, global positioning systems (GPS) may be used for assisting a driver with navigation. In another example, an image capture device, such as a camera, may be used to capture images for use in interpreting visual cues, such as highway lines, for guiding a vehicle on a roadway.

Although advancements have been made, it can be very complicated for an autonomous vehicle to effectively navigate turns which may otherwise be simple for human drivers. For example, a human can easily discern the speed and turn angle at which an automobile should be controlled for attempting to turn a sharp U-turn; however, such a turn may be difficult for an autonomous vehicle. In addition, navigation within small spaces, such as a parking deck, can be difficult for autonomous vehicles. Therefore, for at least these reasons, it is desired to provide improved systems and techniques for automated control of vehicles for navigation.

### BRIEF SUMMARY

In accordance with one or more embodiments of the present invention, systems and methods for vehicle control based on colors representative of navigation information are provided. According to an aspect, a method includes receiving an image of an object surface having multiple colors thereon that are representative of data for use in navigating a vehicle along a pathway. Further, the method includes controlling the vehicle to operate to navigate the pathway based on the image.

According to another aspect, a method includes receiving navigation information associated with a pathway. Further, the method includes determining, based on the navigation information, multiple colors to present for image capture by a computing device for use in navigating a vehicle along the pathway.

### BRIEF DESCRIPTION OF THE SEVERAL VIEWS OF THE DRAWINGS

The patent or application file contains at least one drawing executed in color. Copies of this patent or patent application publication with color drawing(s) will be provided by the Office upon request and payment of the necessary fee.

FIG. 1 is a perspective view of an automobile 100 implementing a vehicle control system based on colors representative of navigation information in accordance with embodiments of the present invention;

FIG. 2 is a block diagram of an example system for vehicle control based on colors representative of navigation information in accordance with embodiments of the present invention;

FIG. 3 is a flowchart of an example method for vehicle control based on colors representative of navigation information in accordance with embodiments of the present invention;

FIG. 4 is an image of a color code for use in determining a turn angle for navigating a turn in accordance with embodiments of the present invention;

FIGS. 5A-5D illustrate diagrams depicting example turning pathways that a vehicle may encounter along with a color code for navigation of the respective pathway in accordance with embodiments of the present invention;

FIG. 6 is a diagram of a vehicle, pathway, and color code for use in navigating the pathway in accordance with embodiments of the present invention;

FIG. 7 is a diagram of an example color code providing information regarding speed and turn length for navigating a pathway in accordance with embodiments of the present invention;

FIGS. 8A-8D illustrate diagrams depicting example turning pathways that a vehicle may encounter along with a color code for navigation of the respective pathway in accordance with embodiments of the present invention;

FIGS. 9A-9C show diagrams depicting example turning pathways that a vehicle may encounter along with a color code for navigation of the respective pathway in accordance with embodiments of the present invention;

FIGS. 10A-10C show diagrams depicting example turning pathways that a vehicle may encounter along with a color code for navigation of the respective pathway in accordance with embodiments of the present invention;

FIGS. 11A and 11B illustrate respectively a diagram of an example x-y graph for vector determination and an example hue indicator color code in accordance with embodiments of the present invention;

FIGS. 12A and 12B illustrate a flowchart of an example method for acquiring radial data change in HSL/HSV encoded data strip in accordance with embodiments of the present invention; and

FIG. 13 is a flowchart of an example method for generating colors for use in navigating a vehicle along a pathway in accordance with embodiments of the present invention.

### DETAILED DESCRIPTION

As described herein, there are various embodiments and aspects of the present invention. According to embodiments, the present invention is directed to systems and methods for vehicle control based on colors representative of navigation information.

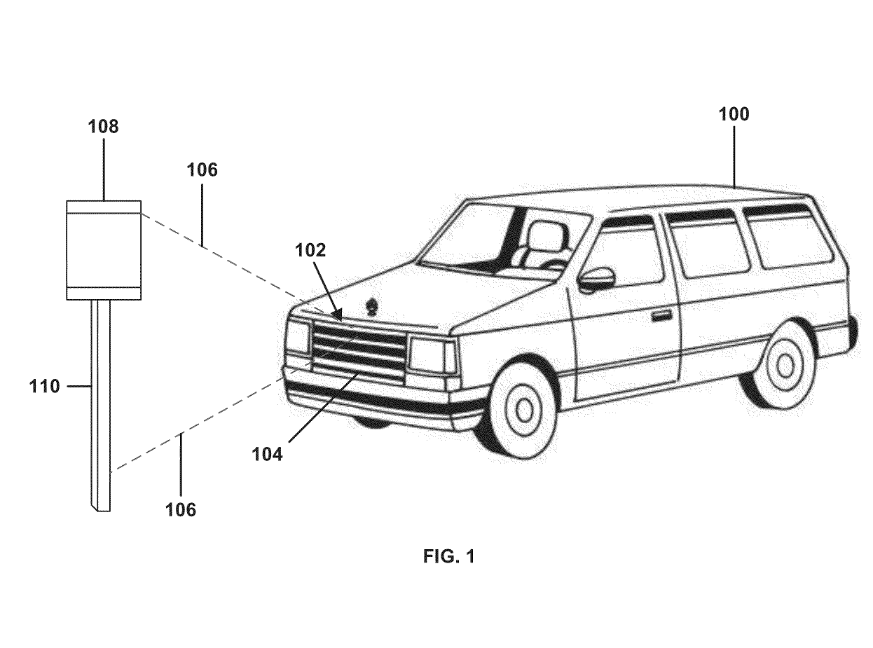

FIG. 1 illustrates a perspective view of an automobile 100 implementing a vehicle control system based on colors representative of navigation information in accordance with embodiments of the present invention. Referring to FIG. 1, the automobile 100 may include an image capture device 102 configured to capture one or more images or video. The image capture device 102 may be positioned within a front grill 104 of the automobile 100 and facing forward for capturing images of objects and scenery positioned forward of the automobile 100. In this example, the image capture device 102 is positioned to capture images of objects and scenery within a field of view designated by broken lines 106. The field of view 106 includes a portion of road sign 108 supported by a post 110.

A surface of the road sign 108 is colored with multiple colors that are representative of data for use in navigating a vehicle along a pathway. The image capture device 102 may capture an image of the object surface having the colors. The image capture device 102 may generate image or video data based on the captured image and may include an output for communicating the data. The vehicle 100 may include a computing device (not shown in FIG. 1) in communication with the image capture device 102 and configured to receive the image/video data output by the image capture device 102. The computing device may be configured to control the vehicle 100 to operate to navigate a pathway based on the captured image. In this example, the pathway may be a roadway near the road sign 108. The colors and their arrangement on the road sign 108 may be indicative of information for use in controlling vehicles to navigate the roadway. As an example, the data may specify a speed, a velocity, a distance, a turn angle, a turn length, the like, or combinations thereof for navigating the pathway.

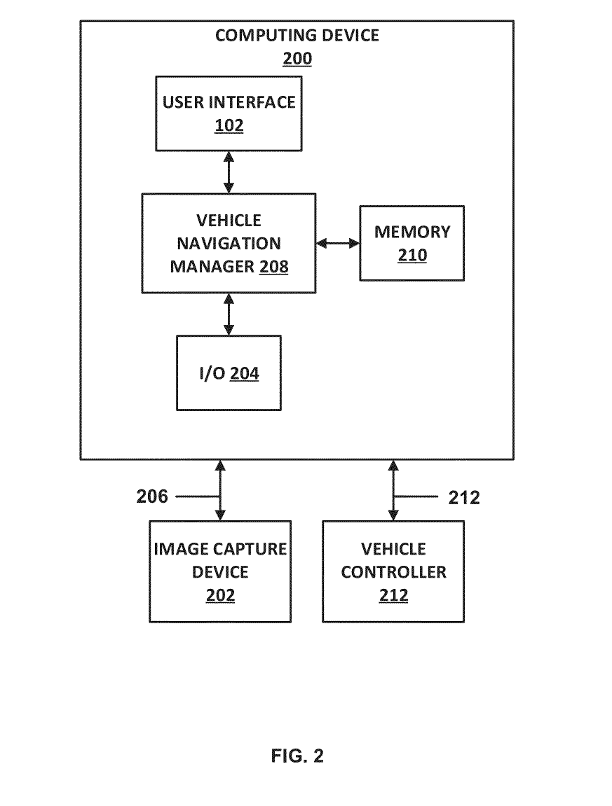

FIG. 2 illustrates a block diagram of an example system for vehicle control based on colors representative of navigation information in accordance with embodiments of the present invention. Referring to FIG. 2, the system includes a computing device 200 and an image capture device 202. The computing device 200 and the image capture device 202 may be operatively connected. For example, the computing device 200 may include an input/output (I/O) device 204 configured for connection to the image capture device 202. The image capture device 202 may generate image or video data based on captured image(s) or video, and may subsequently communicate the data to the computing device 200 via a wire connection 206. The I/O device 204 may receive the data, and a vehicle navigation manager 208 may store the data in a memory 210.

The vehicle navigation manager 208 may include hardware, software, firmware, or combinations thereof for implementing the functions described herein. For example, the navigation manager 208 may include one or more processors and memory for implementing the disclosed functions. The vehicle navigation manager 208 may control a vehicle, such as the vehicle 100 shown in FIG. 1, to navigate a pathway, such as a turn, based on one or more captured images. For example, the vehicle navigation manager 208 may analyze data of a captured image of an object surface having multiple colors thereon that are representative of data for use in navigating a vehicle along a pathway. The vehicle navigation manager 208 may generate instructions for controlling the vehicle based on the colors, and may communicate the instructions to a vehicle control unit 212 via a wire connection 214. The vehicle control unit 212 may include devices for controlling the vehicle. For example, the vehicle control unit 212 may include servos for controlling braking, steering, throttling, and the like. As described in further detail herein, the vehicle navigation manager 208 may analyze colors presented in one or more images and may determine control instructions for the vehicle controller 212 for navigating a pathway based on the image(s).

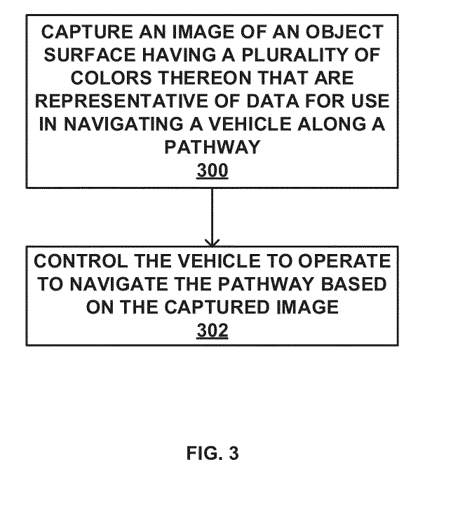

FIG. 3 illustrates a flowchart of an example method for vehicle control based on colors representative of navigation information in accordance with embodiments of the present invention. The example method is described in examples as being implemented by the vehicle navigation manager 208 shown in FIG. 2 and the vehicle 100 shown in FIG. 1; however, it should be understood that the method can be implemented by any suitable computing device and vehicle.

Referring to FIG. 3, the method includes receiving 300 an image of an object surface having a plurality of colors thereon that are representative of data for use in navigating a vehicle along a pathway. For example, the image capture device 202 may capture an image of an object surface, such as the road sign 108 shown in FIG. 1. The object surface may include multiple colors varied along its surface. The color variance may be indicative of information for navigating a roadway. For example, the color variance may be indicative of a speed, a velocity, a distance, a turn angle, a turn length, the like, and combinations thereof for navigating a section of the roadway in front of a vehicle, such as the vehicle 100 shown in FIG. 1. In another example, the color variance may be indicative of a change of a speed, a velocity, a distance, a turn angle, a turn length, the like, and combinations thereof for navigating a section of the roadway. In another example, the data may specify an order of a sequence of turns for navigating the pathway.

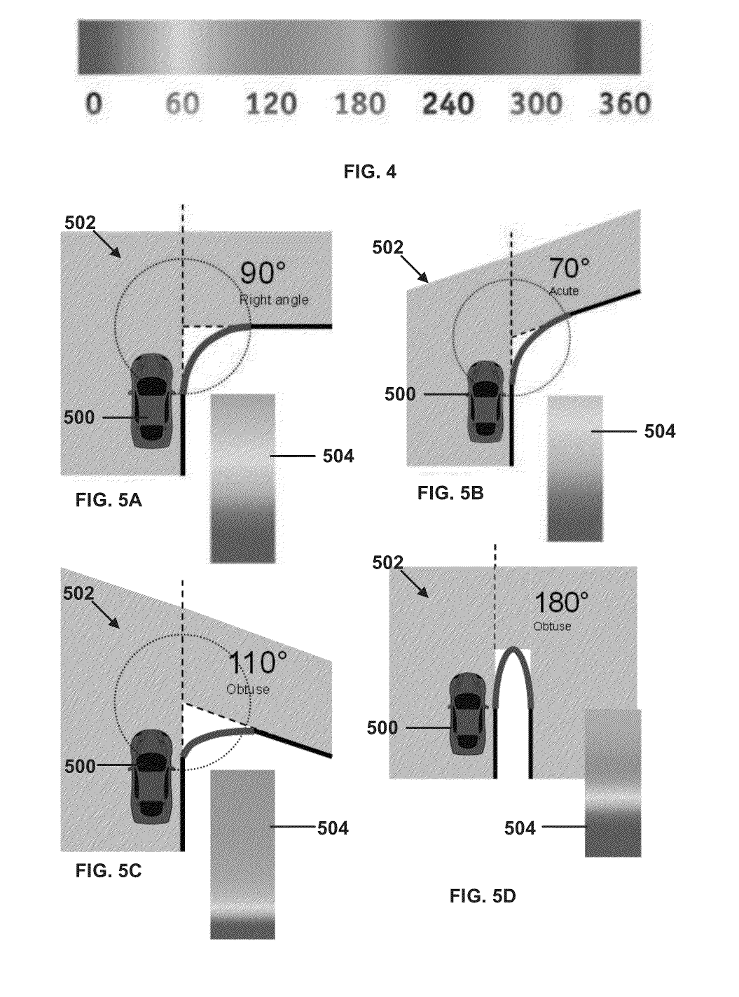

As an example, FIG. 4 illustrates an image of a color code for use in determining a turn angle for navigating a turn in accordance with embodiments of the present invention. Referring to FIG. 4, the color code uses a hue, saturation, and lightness (HSL) or hue, saturation, and intensity (HIS) cylindrical-coordinate representation of points in an RGB color model for indicating parameters for determining effective navigation of a turn. Through the capturing of these variations, autonomous systems may characterize turning parameters. Turns or other parameters may be described and characterized using colors shown in the image of FIG. 4. Such colors may be painted or otherwise applied to a road sign or a surface on or nearby the road and used to characterize turns at various angles. Hue values may range between 0 and 360 degrees, which may be indicative of the angle of which a vehicle should turn. In this example, the colors correspond to the turn angles in degrees and indicated below the color strip.

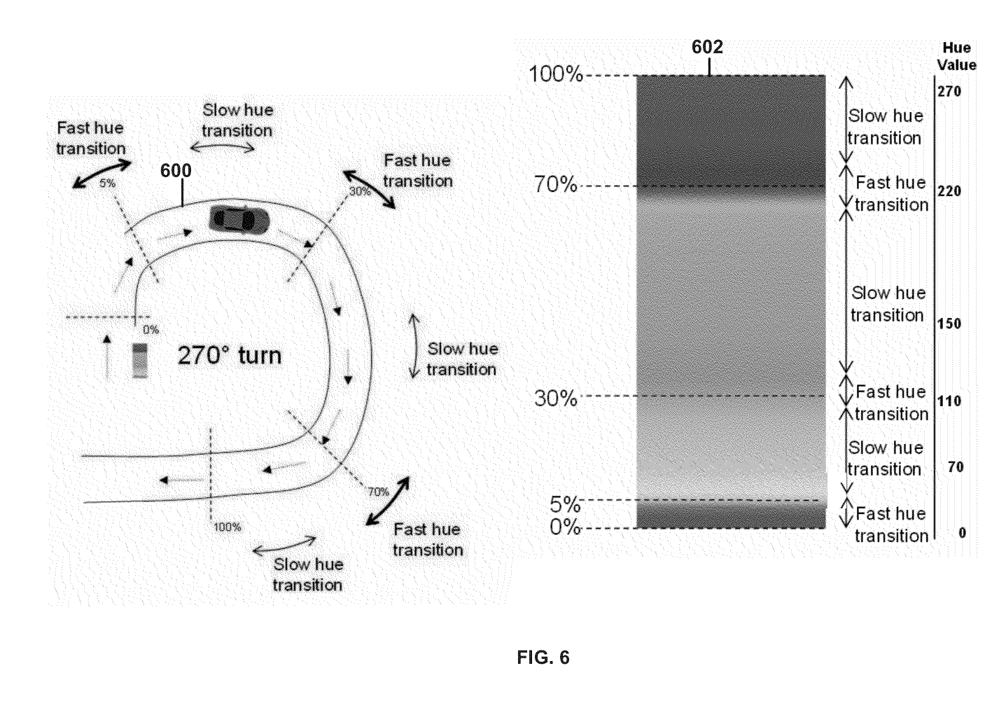

FIGS. 5A-5D illustrate diagrams depicting example turning pathways that a vehicle may encounter along with a color code for navigation of the respective pathway in accordance with embodiments of the present invention. Referring to FIGS. 5A-5D, each figure shows a vehicle 500 traveling along a roadway, generally designated 502. Each roadway 502 requires a different turn angle. Color codes 504 show the color code that may be posted for image capture to indicate navigation of the turn by the vehicle 500. Particularly, FIG. 5A shows a right turn angle at 90 degrees with smooth, circular arc between the beginning and end of the turn. The start and end colors located at the top and bottom of the color code shown in FIG. 5A represents a numeric hue change of 90, which may be interpreted when captured for determining when the turn is complete. The smooth transition is incremented consistent by even hue intervals. The change in hue is 90, the change in saturation is 0, and the change in lightness value is 0. In this case, the vehicle 500 will have turned 90 degrees. The evenly consistent transition of hue across the color code in FIG. 5A also indicates that the turn is smooth, therefore the steering servo may be controlled to turn the wheel at a constant angle throughout the turn to effectively navigate the turn from the start to finish. FIG. 5B shows a smooth transition incremented consistently by even hue intervals (change in hue is 70, change in saturation is 0, and the change in lightness value is 0). In FIG. 5C, there is a quick transition from 0-20% of the turn, and a slow transition from 20-80% of the turn. The change in hue is 110, the change in saturation is 0, and the change in lightness value is 0. Further, in FIG. 5C, the transition of hue is not smooth across the whole color code because in the first 20% of the turn, the vehicle must turn sharply, and then the turn may ease through the remaining 80% of the turn. In FIG. 5D, there is a slow transition from 0-40% of the turn, a quick transition between 40-60% of the turn, and a slow transition from 60-100% of the turn. The change in hue is 180, the change in saturation is 0, and the change in lightness value is 0.

Now returning to FIG. 3, the method includes controlling 302 the vehicle to operate to navigate the pathway based on the image. Continuing the aforementioned example, the vehicle navigation manager 208 may determine control inputs for servos of the vehicle control unit 212 to navigate a pathway, such as the pathway 502 shown in FIGS. 5A-5D. Based on the angles or the like indicated by a color code, such as the color codes 504 shown in FIGS. 5A-5D, the vehicle navigation manager 208 may control the servos to navigate along the pathway. These colors codes may be placed on road signs or any other object having a surface in a field of view of an image capture device on a vehicle.

In accordance with embodiments of the present invention, an indicator may inform the vehicle navigation manager 208 when to begin control for navigating a pathway. For example, the image capture device 202 may capture an image providing indication when to begin. As an example, the indicator may be a line or other indicator on a roadway, sign, or other surface. In this way the vehicle navigation manager 208 may receive an indicator of a start of a pathway. Subsequently, the vehicle navigation manager 208 may determine the start of the pathway, and initiate control of the vehicle to operate to navigate the pathway based on the captured image and in response to determining the start of the pathway. In another example, GPS may be used for indicating the start of the pathway. With this method, variation in color may indicate the geographic coordinates representative of the beginning or end of the navigation path and therefore work in conjunction with an embedded GPS navigation system in a vehicle to begin navigating a pathway. Alternatively, as another example to begin control for navigation of a pathway, upon camera capture of an image containing a plurality of colors representing a path, a laser rangefinder could be utilized to determine distance between the image (e.g. road sign) and the vehicle. In this scenario, the navigation pathway would start when the vehicle has traversed the laser rangefinder indicated distance from the initial vehicle location at the time image capture.

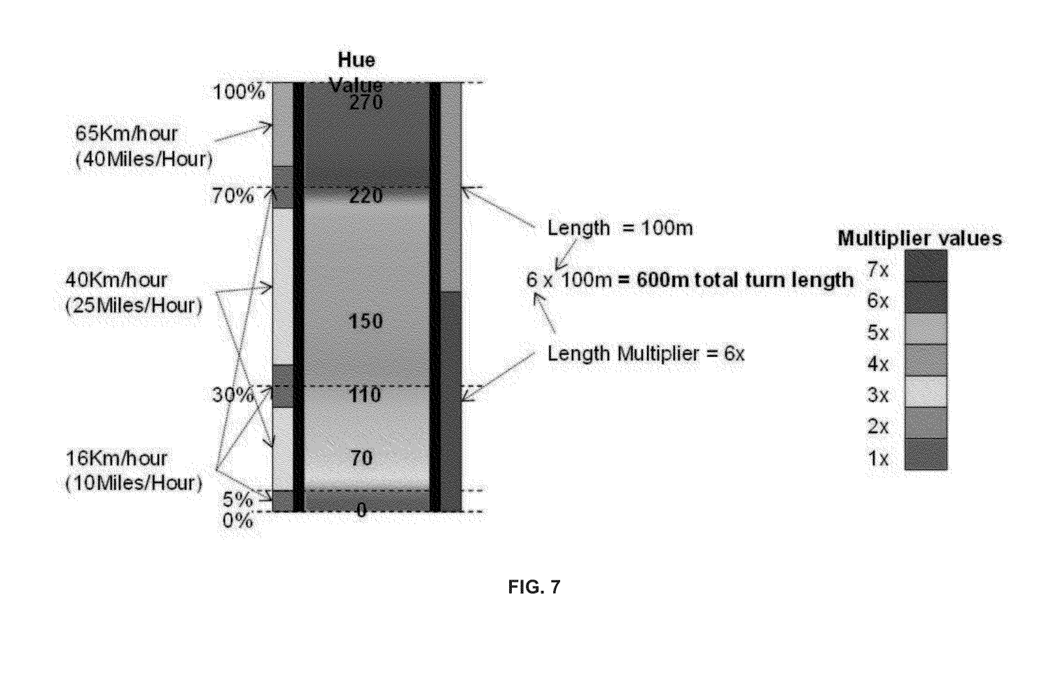

FIG. 6 illustrates a diagram of a vehicle 100, pathway 600, and color code 602 for use in navigating the pathway in accordance with embodiments of the present invention. Referring to FIG. 6, the pathway 600 in this example is a cloverleaf style on-ramp for driving from a street road to an interstate highway. The color code 602 has colors that correspond to a length of the pathway from the beginning (0%) to the end (100%). The corresponding hue values is shown as being between 0 degrees and 270 degrees, thus the turn is a 270 degree turn. Further, there is a fast hue transition at 5% where there is a somewhat sharp turn. The hue transition is slow between 5% and 30%. At 30%, there is another somewhat sharp turn where the hue transition is fast. Between 30% and 70%, the hue transition is slow. Next, at 70%, there is a somewhat sharp turn where the hue transition is fast. Next, between 70% and 100% of the turn, the hue transition is slow. Therefore, the colors and hue transitions shown from bottom to top of the color code specify instructions for navigating the pathway 600.

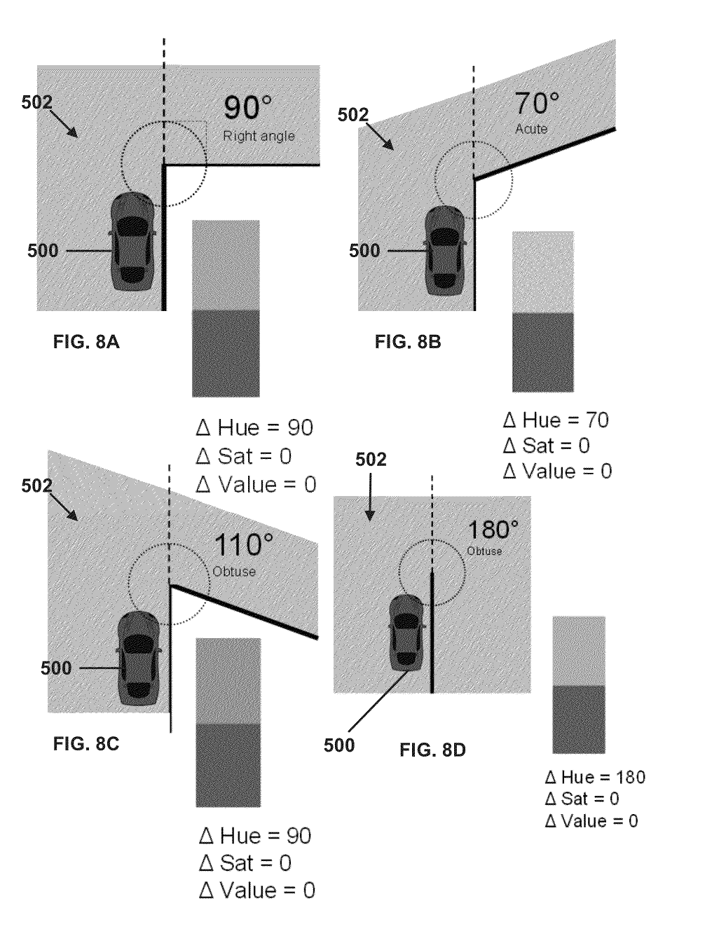

FIG. 7 illustrates a diagram of an example color code providing information regarding speed and turn length for navigating a pathway in accordance with embodiments of the present invention. Referring to FIG. 7, the color code on the left indicates various speed instructions for different portions along the turn. The transitional speed limit hue of the color code is defined in kilometers per hour (km/hour). As an example, 0 km/hour is designated by hue 0, 10 km/hour is designated by hue 10, and 120 km/hour is designated by hue 120. Length may be determined by multiplying initial hue value by end hue value. To ensure distinguishable color variations, multipliers may be used for the initial hue as shown in the multiple hue value chart shown on the right. Overall length may be defined by any suitable length value (e.g., meters, feet, yard, etc.). For example, red*blue=1*220=220 meters. In another example, orange*blue=2*220=440 meters. In another example, blue*green=6*100=600 meters.

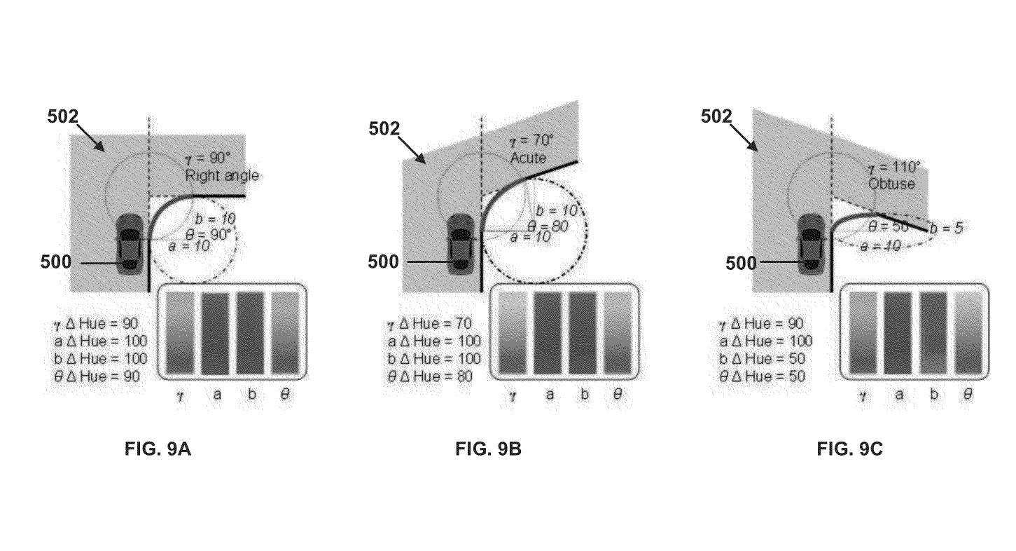

FIGS. 8A-8D illustrate diagrams depicting example turning pathways that a vehicle may encounter along with a color code for navigation of the respective pathway in accordance with embodiments of the present invention. Referring to FIGS. 8A-8D, each figure shows a vehicle 500 traveling along a roadway, generally designated 502. Each roadway 502 requires a different turn angle. It is noted that when (or if) the arc of which the turn is considered negligible or standardized, it may not be required to provide an incremental hue transition as only the overall angle of the turn would be required as indicated in FIGS. 8A-8D.

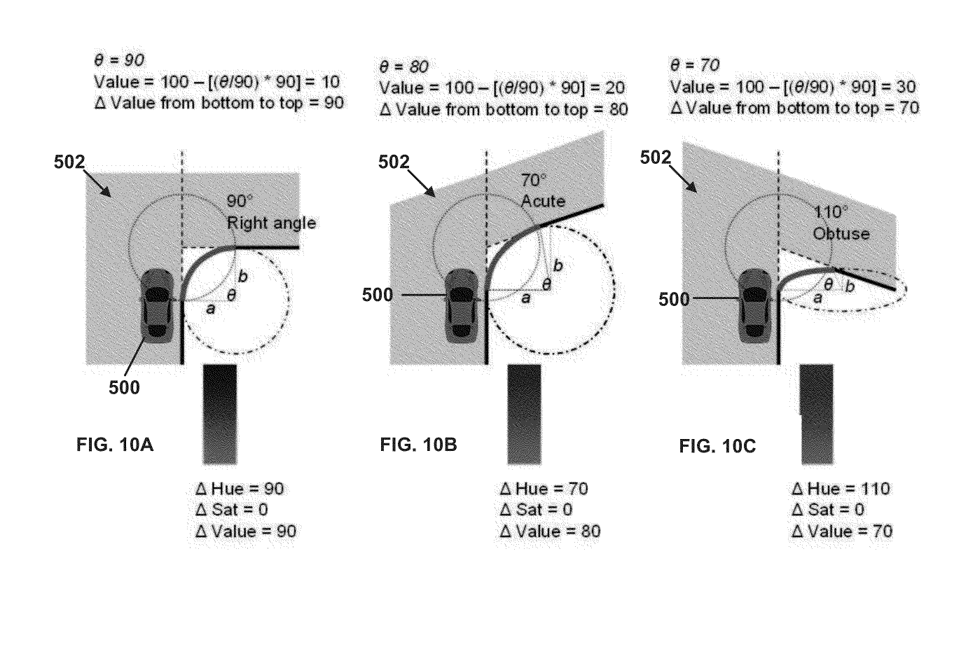

In accordance with embodiments of the present invention, colors may be encoded with data for navigating the arc of an elliptical turn. In which case, additional parameters may be provided as indicated in FIGS. 9A-9C, which show diagrams depicting example turning pathways that a vehicle may encounter along with a color code for navigation of the respective pathway in accordance with embodiments of the present invention. Referring to FIGS. 9A-9C, each figure shows a vehicle 500 traveling along a roadway, generally designated 502. The variables a, b, and θ can be used by a vehicle navigation manager for calculating the elliptical arc length for navigating the turn. It is noted that the values are represented by the change in hue, therefore, the variation for a and b can be different colors.

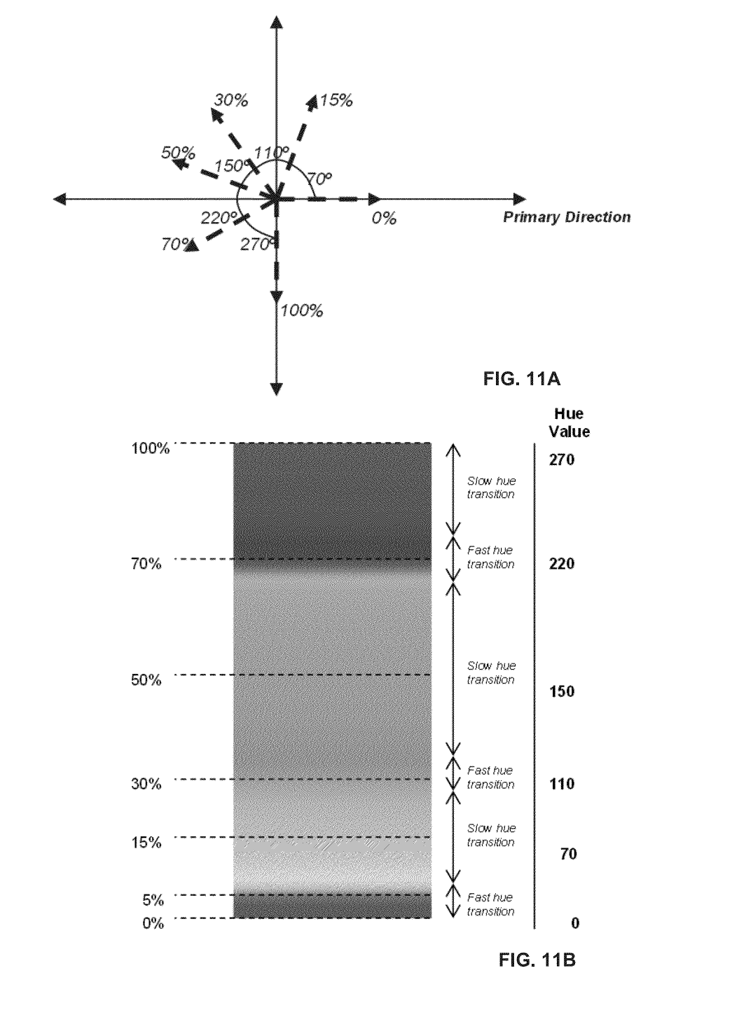

In accordance with embodiments of the present invention, colors may be encoded with data for navigating the arc of an elliptical turn. In which case, additional parameters may be provided as indicated in FIGS. 10A-10C, which show diagrams depicting example turning pathways that a vehicle may encounter along with a color code for navigation of the respective pathway in accordance with embodiments of the present invention. Referring to FIGS. 10A-10C, each figure shows a vehicle 500 traveling along a roadway, generally designated 502. In this example, advantage is taken of other parameters available in the HSV or HSL cylindrical-coordinate representation of the RGB color model. Particularly, the angle of θ may be determined by the change of the value parameter in the HSV representation.

In accordance with embodiments of the present invention, a computing device implementing a vehicle navigation manager, such as the manager 208 shown in FIG. 2, may use an image having colors as shown in the examples provided herein for navigating a turn or other pathway. Particularly, the vehicle navigation manager may determine parameters for navigating a roadway based on the information coded in the colors and their arrangement for determining instructions for controlling a vehicle for navigating the roadway. The vehicle navigation manager may control, for example, servos or other components of a vehicle for navigating the pathway as specified in the information contained in the colors and their arrangement.

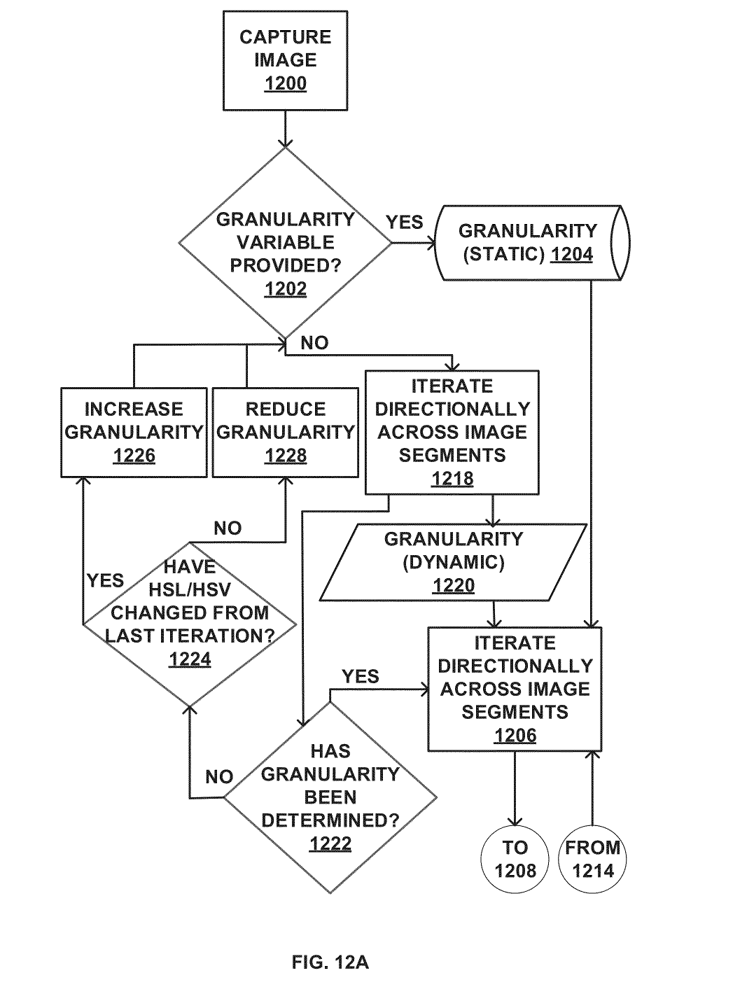

In accordance with embodiments of the present invention, FIGS. 11A and 11B illustrate respectively a diagram of an example x-y graph for vector determination and an example hue indicator color code. FIG. 11A is the vector based representation of FIG. 11B on a Cartesian plane over the distance of an example pathway. In FIG. 11A, distance of the pathway is represented by the labeled percentage of each vector. In FIG. 11B, distance of the pathway is represented from the bottom of the color varied image from the bottom to top. As distance is incremented, the angle of the vector in FIG. 11A is representative of the variation in hue from the beginning of the pathway or the initial direction of the vehicle (indicated as the primary direction).

In many of the examples described herein, navigation information is provided for right turns, although the disclosure provided herein may be similarly applied for left turns or combination turns having one or more right turns, one or more left turns, and/or other directions.

In many applications of the present invention, objects can be colored and used at low cost for navigation in accordance with embodiments of the present invention. Example applications include, but are not limited to, temporary use for routing vehicles around construction work, such as road construction. As an example, a sticker can have a color code as described herein and placed where a vehicle's image capture device can capture an image of the sticker for use in navigating a construction site. The present disclosure may be used in indoor and outdoor applications.

In accordance with embodiments of the present invention, a display may be controlled to display a color code or another arrangement of colors as an image for capture by an image capture device for use in navigating a vehicle. In this way, the displayed colors may be dynamic and changeable for a variety of purposes. For example, the display may be used in a parking garage setting for directing a vehicle to an available parking space.

In an example use, a color code or other color arrangement as disclosed herein may be used by accident responders in the event of an accident. An image capture device may capture an image of the colors for use in locally distributing navigation information. The navigation information may be wirelessly communicated to autonomous vehicles for use in safely navigating around an accident scene.

In an example use, a color code or other color arrangement as disclosed herein may be used for indoor transit systems such as, but not limited to, airport trams, airport luggage vehicles, manufacturing vehicles (e.g., fork lifts, wafer carts, etc.), and the like.

In accordance with embodiments of the present invention, a vehicle navigation manager may receive indication of an obstruction along a pathway about which colors provide navigation information. In this case, the vehicle may include an override function for preventing the vehicle from proceeding.

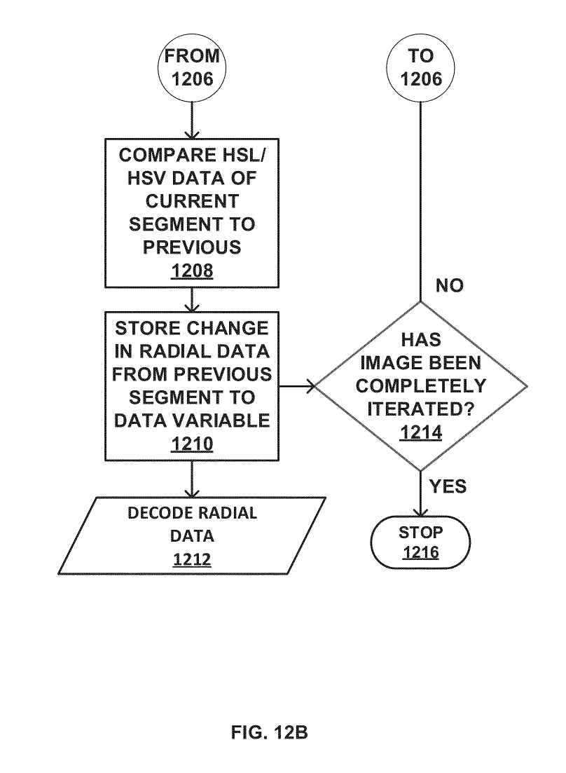

In accordance with embodiments of the present invention, FIGS. 12A and 12B illustrate a flowchart of an example method for acquiring radial data change in HSL/HSV encoded data color strip. The flowchart in FIGS. 12A and 12B may enable an algorithm for dynamically determining how many iterations are required to decode data encapsulated by the color encoded data strip based on the overall granularity of color variations. The method may be implemented by any suitable computing device and image capture device. Referring to FIG. 12A, the method includes capturing an initial image of a color encoded strip. For example, an image capture device may capture an image of the color encoded strip.

The method of FIGS. 12A and 12B includes determining whether a granularity has statically been provided as an input to the algorithm or must be generated dynamically. This determination may be made by a suitable computing device. In response to a determination that a granularity variable is provided, the static granularity variable may be directly provided to the algorithm (block 1204). Subsequent to static granularity being provided, the method includes iterating 1206 directionally across the image segments based on the input granularity. Subsequently, at block 1208 in FIG. 12B, the radial HSL/HSV/HSI color data of the current and previous segment are compared to determine the amount radial change between current and previous segments. Subsequently, the decoded radial data change determined in block 1208 may be stored to a resultant decoded radial data variable. At block 1212, the radial data resultant is decoded. At block 1214, a determination is made of whether the image has been completely iterated over the segments. If the image has been completely iterated over the segments, the method may stop (block 1216). If the image has not been completely iterated over the segments, the method may return to block 1206.

At block 1218, the method includes iterating across the image segments based off of the granularity, starting with the highest possible granularity (the total quantity of pixels contained in one column or row of the image). At block 1222, the method includes determining whether granularity has been determined. In response to determining that granularity has been determined, the method proceeds to block 1206. In response to determining that granularity has not been determined, the method proceeds to block 1224 where it is determined whether color data has changed from the previous iteration. In response to determining that the color data has changed from the previous iteration, granularity is increased (block 1226). In response to determining that the color data has not changed from the previous iteration, the granularity may be reduced (block 1228).

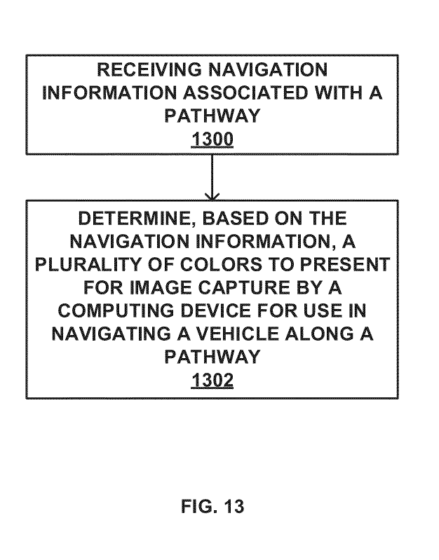

FIG. 13 illustrates a flowchart of an example method for generating colors for use in navigating a vehicle along a pathway in accordance with embodiments of the present invention. The example method is described in examples as being implemented by a suitable computing device having one or more processors and memory. Referring to FIG. 13, the method includes receiving 1300 navigation information associated with a pathway. For example, the computing device may receive information about a pathway, such as turn angles, turn lengths, and the like. Further, for example, the computing device may receive information such as a speed, a velocity, and the like. Such information may be collected by the computing device by use of a GPS unit that collects coordinate data as the GPS unit is moved along the pathway. The computing device may store the coordinate data and convert the data to pathway information, such as turn angles, turn lengths, and the like.

The method of FIG. 13 includes determining 1302, based on the navigation information, a plurality of colors to present for image capture by a computing device for use in navigating a vehicle along the pathway. Continuing the aforementioned example, the computing device may use the navigation information to determine a plurality of colors and their arrangement for presentation to navigate a vehicle along the pathway. The colors may be arranged in accordance with examples disclosed herein. Further, a surface may be colored with the colors in the determined arrangement. As an example, object surfaces that may be colored include a sign and a sticker. Further, a display can be controlled to display the colors.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium (including, but not limited to, non-transitory computer readable storage media). A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing. Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter situation scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular embodiments only and is not intended to be limiting of the invention. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A method comprising:
receiving an image of an object surface having a plurality of colors thereon that are representative of data for use in navigating a vehicle along a pathway; and
controlling the vehicle to operate to navigate the pathway based on the image.

2. The method of claim 1, wherein receiving the image comprises capturing an image of the object surface.

3. The method of claim 1, wherein receiving the image comprises using an image capture device to capture the image.

4. The method of claim 1, wherein the data specifies one of a speed, a velocity, a distance, a turn angle, and a turn length.

5. The method of claim 1, wherein the data specifies an order for a sequence of turns for navigating the pathway.

6. The method of claim 1, wherein the colors are varied along the object surface, and, wherein the color variance is indicative of information for navigating the pathway.

7. The method of claim 6, wherein the color variance is indicative of a speed, a velocity, a distance, a turn angle, and a turn length.

8. The method of claim 6, wherein the color variance is indicative of a change in one of a speed, a velocity, a distance, a turn angle, and a turn length.

9. The method of claim 1, wherein a color is the same or similar on a portion of the object surface to indicate a consistent one of a speed, a velocity, a distance, a turn angle, and a turn length.

10. The method of claim 1, further comprising:
receiving an indicator of a start of the pathway;
determining the start of the pathway; and
in response to determining the start of the pathway, initiating the control of the vehicle to operate to navigate the pathway based on the image.

11. A method comprising:
using at least a processor and memory for:
receiving navigation information associated with a pathway; and
determining, based on the navigation information, a plurality of colors to present for image capture by a computing device for use in navigating a vehicle along the pathway.

12. The method of claim 11, further comprising determining an arrangement of the colors for presentation to be representative of the navigation information.

13. The method of claim 12, wherein the colors and the color arrangement specify one of a speed, a velocity, a distance, a turn angle, and a turn length for navigating the pathway.

14. The method of claim 12, wherein the colors and the color arrangement specify an order for a sequence of turns for navigating the pathway.

15. The method of claim 11, further comprising coloring an object surface with the plurality of colors.

16. The method of claim 15, wherein coloring the object surface comprises coloring the object surface with the plurality of colors in a predetermined arrangement for representing the navigation information.

17. The method of claim 15, wherein the colors are varied on the object surface, and
wherein the color variance is indicative of information for navigating the pathway.

18. The method of claim 15, wherein the colors are varied on the object surface, and
wherein the color variance is indicative of a speed, a velocity, a distance, a turn angle, and a turn length.

19. The method of claim 15, wherein the colors are varied on the object surface, and
wherein the color variance is indicative of a change in one of a speed, a velocity, a distance, a turn angle, and a turn length.

20. A system comprising:
an image capture device configured to capture an image of an object surface having a plurality of colors thereon that are representative of data for use in navigating a vehicle along a pathway; and
a vehicle navigation manager comprising a memory and processor configured to control the vehicle to operate to navigate the pathway based on the captured image.
